(19) United States
(12) Patent Application Publication
(10) Pub. No.: US 2005/0022136 A1
(43) Pub. Date: Jan. 27, 2005

(54) Methods and systems for manipulating an item interface

(76) Inventors: Michael Hatscher, Osnabruck (DE); Joerg Beringer, Frankfort (DE); Chinhao Lee, Mountain View, CA (US); Eric Wood, Menlo Park, CA (US)

Correspondence Address: FINNEGAN, HENDERSON, FARABOW, GARRETT & DUNNER;LLP, 1300 I STREET, NW, WASHINGTON, DC, 20005, US

(21) Appl. No.: 10/846,691

(22) Filed: May 17, 2004

(30) Foreign Application Priority Data
May 16, 2003 (EP) 03011000.1
Oct. 17, 2003 (EP) 03078294.0

(51) Int. Cl. G09G 5/00

(52) U.S. Cl. 715/798; 715/788; 715/801; 715/799; 715/800; 715/802; 715/734; 715/738; 715/739; 715/853; 715/854; 715/855

(57) ABSTRACT

A graphical user interface includes a graphical user interface, which includes an item interface in which at least two items can be listed. In an expanded state, the item interface has a collapse control for bringing the item interface in a collapsed state in which the dimensions of the item interface are partially reduced and at least some of the items are not visible. In a collapsed state, the item interface has a expand control for bringing the item interface into the expanded state.

This application is based upon and claims the benefit of priority from prior patent application EP 03011000.1, filed May 16, 2003, and prior patent application EP 03078294.0, filed Oct. 17, 2003, the entire contents of each which are expressly incorporated herein by reference.

### BACKGROUND

I. Technical Field

The present invention relates to a methods and systems for manipulating an item interface.

II. Background Information

Computer systems typically have a user interface that includes a display. Such user interface is described as a graphical user interface (GUI), which has a graphical program interface, in which a window displays a list of items or icons. The list of items may represent a sequence of steps to be performed by a user or may be a list of files and folders present in the computer system, for example.

Typically, the list of items is arranged for display in a tree-shaped manner. In addition, the leaves of the tree can be collapsed or expanded to change the amount of information presented. The computer system further may include a control for closing the window to remove it from the display. The window can be re-opened via suitable controls and be shown in the user interface again. This functionality thus facilitates a decrease in the amount of the GUI area that is occupied by the list of items so as to release space in which, for example, other information can be presented.

However, in such a computer system, if the leaves of the tree are merely collapsed or expanded, the size of the window remains the same, and thus the amount of GUI space occupied by the windows is not reduced. Furthermore, if the window is removed, the window is not visible anymore. This may confuse the user of the computer system.

Another drawback of such a computer system is that re-opening the window may be a complex operation. In one way of re-opening the window, the user first has to select (by means of a mouse or other input device) an item in a menu present at the GUI. In response to the selection, a sub-menu is opened, which is associated with the selected item in the menu. The sub-menu has a suitable control to re-open the window. This requires the user to remember which item has to be selected to reveal the submenu. The window may also be re-opened by pressing a certain combination of keyboard keys. However, this requires the user to memorize the specific combination. In view of the foregoing, there is a need for more efficient and user-friendly systems and methods of manipulating a GUI.

### SUMMARY OF THE INVENTION

An item interface can be collapsed via a collapse control. In the collapsed state, the dimensions of the item interface are reduced partially. Thus, the item interface is still present in the user interface and can be noticed by the user, while reducing the amount of a GUI area that is occupied by the item interface. Accordingly, a user is not confused by the absence of the item interface in the user interface.

In addition, the user can easily bring the collapsed item interface into the expanded state via the expand control. Thus, the user does not have to follow a complex procedure to bring the item interface into the expanded state or to memorize the specifics steps of the complex procedure.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 shows an example of a computer system consistent with the invention;

FIG. 2 shows a first example of a GUI consistent with the invention, with an item interface in an expanded state;

FIG. 3 shows the first example of a GUI with the item interface in a collapsed state;

FIG. 4 shows a second example of a GUI consistent with the invention, with an item interface in a collapsed state;

FIG. 5 shows a third example of a GUI consistent with the invention, with an item interface in an expanded state;

FIG. 6 shows the third example of a GUI with the item interface in a collapsed state; and

FIGS. 7a-7b show an interface in a collapsed state and an expanded state.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

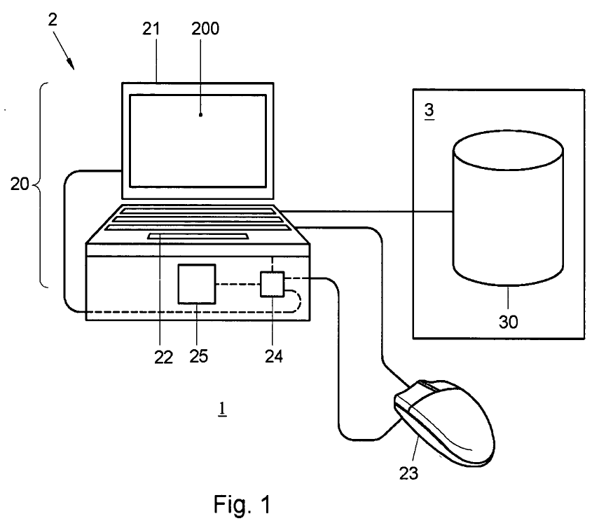

FIG. 1 shows an example of a computer system 1 that comprises a computer device 2. Computer system 1 further comprises a server system 3 with a database 30. In FIG. 1, computer device 2 is communicatively connected to server system 3 and database 30. Computer system 1 may also be a stand-alone system and/or be connected to other resources than database 30. For example, database 30 may be a part of computer device 2 and may be positioned inside computer device 2 instead of server system 3 or computer device 2 may be connected to a computerized enterprise management system, such as systems provided by SAP AG of Walldorf, Germany.

Computer device 2 is also provided with a user interface (UI) 20. User interface 20 comprises an input interface, such as a keyboard 22 and a mouse 23, by which the user can input data into the computer device. Computer device 2 further comprises an output interface at which data can be outputted in a perceptible form to a user. In this example, the output interface comprises a monitor 21 by means of which data can be outputted visually in a graphical user interface 200.

Both the output interface and the input interface may comprise other components than those depicted in FIG. 1, such as an electronic writing pad, acoustic output, or input devices. Furthermore, the input and output interface may at least be partially integrated in the same device, such as in a touch screen.

In the example computer system of FIG. 1, actions performed by a user by means of keyboard 22 and mouse 23 are graphically represented on the GUI 200 by computer system 1. In this example, when actions are said to be performed by a user at GUI 200, the actions are performed by means of keyboard 22 and mouse 23, but graphically represented at GUI 200. However, it is likewise possible to combine GUI 200 and the input interface, for example in a touch screen. In such a combined GUI and input interface, actions said to be performed by a user at the GUI are both represented and performed at the GUI.

Computer device 2 in the example shown in FIG. 1 further comprises a processor 24 that is communicatively connected to monitor 21, keyboard 22, mouse 23, and a memory 25, as is indicated by lines in FIG. 1. Processor 24 is, among other things, able to handle input from the input interface, and may provide monitor 21 with data that is to outputted at GUI 200. Processor 24 may be arranged to perform other operations as well, such as routing received or outputted data to other devices, or manipulating data.

A computer program may be run on computer device 2. When the computer program is running on computer device 2, processor 24 performs instructions according to program code stored in memory 25. The computer program may, for example, be a program for storing, categorizing and/or ordering items in database 30 or may, for example, be a web browser program that allows access to resources, such as applications, data, and services of a computerized enterprise management system, such as those provided by SAP AG of Walldorf, Germany.

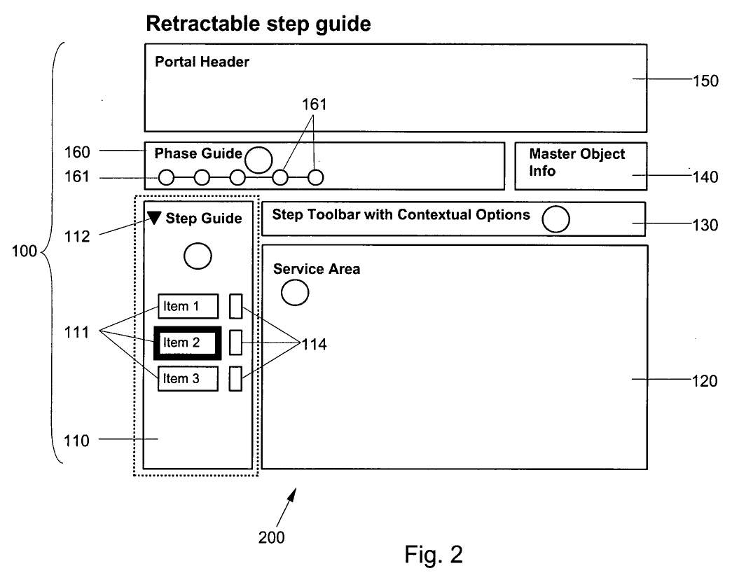

In the examples shown in FIGS. 2-6, the computer program is a program that guides a user through a procedure of steps using resources present in server system 3 and/or computer device 2 and/or other apparatuses connected to computer device 2, such as database 30. The procedure may, for example, perform a number of actions to be taken by the user to achieve a certain goal or may perform a sequence of steps to be performed by computer device 2 under control of an operator. An example of such a program is known from a United States provisional patent application filed by the applicant titled Guided Procedures, the disclosure of which is hereby expressly incorporated herein by reference.

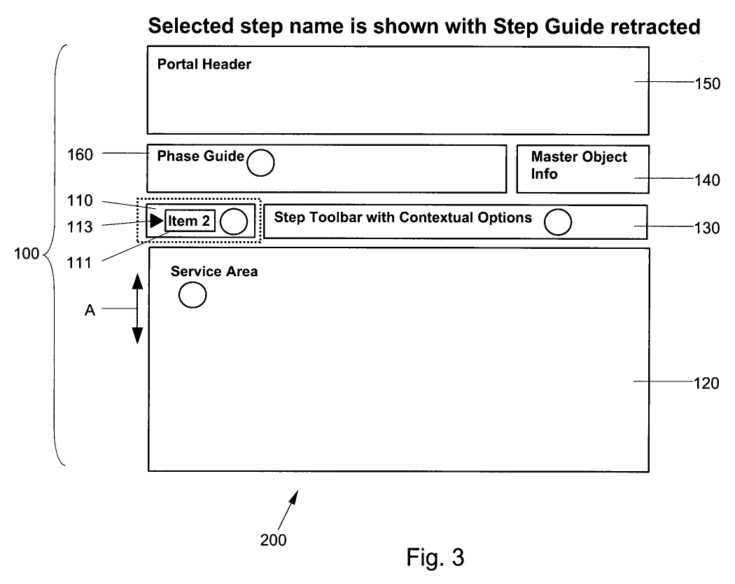

In the examples shown in FIGS. 2-3, a graphical program interface 100 is shown in GUI 200 when the computer program is running. Graphical program interface 100 is a graphical representation of a part of the computer program running on computer device 2. In the examples shown in FIGS. 2-6, graphical program interface 100 occupies the whole area of GUI 200. However, graphical program interface 100 may likewise only occupy a portion of GUI 200 and other interfaces, such as from other computer programs running simultaneously, may likewise be present in GUI 200.

In the examples shown in FIGS. 2-6, graphical program interface 100 comprises several sub-interfaces, such as a service area 120, a contextual interface 130, a master object information window 140, a phase guide interface 160, and a portal header 150. The sub-interfaces are explained below in further detail.

In portal header 150, general information can be provided, as well as controls that are used, for example, to select a certain procedure. In master object information window 140, information about the selected procedure is shown. Such information may include the name of the procedure and the person or computer performing the procedure.

Graphical program interface 100 further comprises an item interface 110, which includes a step guide displaying a list of items 111 (item1, item2 and item3). In this example, these items represent steps to be performed by the user or the computer system. The steps shown in item interface 110 are associated with one or more selected items in another interface. In this example, a selected one of items 111 phase item 161 shown in phase guide interface 160. However, items 111 may represent something else and/or not be associated with items in another sub-interface or interface.

In the example shown in FIGS. 2-4, item interface 110 is provided with various event controls, such as collapse controls 112/162 and expand control 113, for performing steps that can be initiated and associated with one or more of the items. For example, event controls may be implemented as hyperlinks by displaying specific information associated with a selected item that can be initiated in service area 120. However, other steps associated with an item may also be initiated by means of event controls, such as running a computer program associated with the item or displaying further steps to be performed by the user that are associated with the item. Item interface 110 is further provided with check boxes 114, associated with items 111, that the user may use to indicate which steps have been performed. In response to checking a box 114 that is associated with an item, the computer system may automatically select a next step to be performed. For example, as shown in FIG. 2, if items item1, item2 and item3 represent successive steps, when box 114 near item1 is checked, item2 is selected automatically as the active step.

Referring to FIG. 2, item interface 110 is provided with a collapse control 112 by means of which dimensions of item interface 110 can be reduced partially. Item interface 111 can be brought from an expanded state (as shown in FIG. 2) into a collapsed state (as shown in FIG. 3) by means of the user reflecting control 112. Control 112 may, for example, be a button that can be selected by a user by means of a cursor and mouse 23, as shown in the examples of FIGS. 2-7. However, such a control may also be implemented differently and be activated in response to another action at a GUI, such as change of dimensions of another sub-interface or interface at the GUI. As shown in FIG. 3, after selecting a control 113, item interface 110 is changed to a collapsed state and more space is available in the user interface 120 for other parts of graphical program interface 100.

In FIG. 2, item interface 110 is shown in an expanded state and item 2 has been selected by the user, as indicated by the bold rendering in FIG. 2. If a user activates control 112, item interface 110 is reduced to a collapsed state as shown in FIG. 3. In a collapsed state selected item 2 is displayed in item interface 110 with reduced dimensions. The items that were not selected in FIG. 2 (item1 and item3) are not visible in the collapsed state of FIG. 3. Thus, in the collapsed state, a user may perceive which item(s) are selected in item interface 110. An example of such a “step guide” is described in the European patent application 03011000.1 of May 16, 2003, which is incorporated herein by reference.

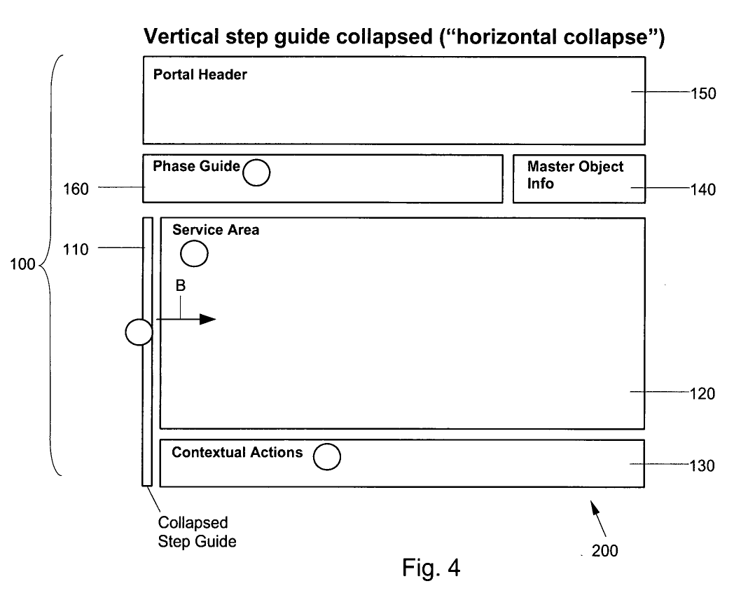

As shown in FIG. 3, service area 120 occupies the space that is made available by bringing item interface 110 from an expanded state into a collapsed state. As shown in FIGS. 3-4, in a collapsed state, item interface 110 has an expand control 113 for bringing item interface 110 back into an expanded state.

In the example shown in FIGS. 2-3, in the collapsed state, only the vertical dimensions of item interface 110 are reduced, as is indicated with the arrow A. In another example shown in FIG. 4, only the horizontal dimensions of the item interface 110 are reduced when moving between the expanded state and the collapsed state, as is indicated with the arrow B. A collapse and/or expansion in one dimension only, either horizontal or vertical, is convenient to a user.

As shown in FIGS. 2-4, when the item interface is brought from the expanded state into the collapsed state or vice versa, only one side, referred to as the movable side of the interface, is moved. Thus, the movable side lies closer to the fixed side in the collapsed state than in the expanded state. In FIGS. 2-3, the side that may be seen as the bottom of the interface is displaced vertically towards the top of item interface 110.

From FIG. 2 to FIG. 4, the right hand side of item interface 110 is moved towards the left hand side. It is convenient to the user of computer device 2 when only one part of the interface is moving during a transition from an expanded state to a collapsed state or vice versa because the orientation of the user at the GUI is not affected.

As is shown in FIGS. 3-4, in changing from the expanded state to the collapsed state, at least some of items 111 are rendered not visible. For example, in FIG. 3, one item 111 is still visible in the collapsed state. The visible item may be an item selected by the user in the expanded state or an item that is active in the collapsed state. One or more visible items in the collapsed state provide an increased ease of use, because the user can perceive relevant information, such as the items and/or their status, even in the collapsed state.

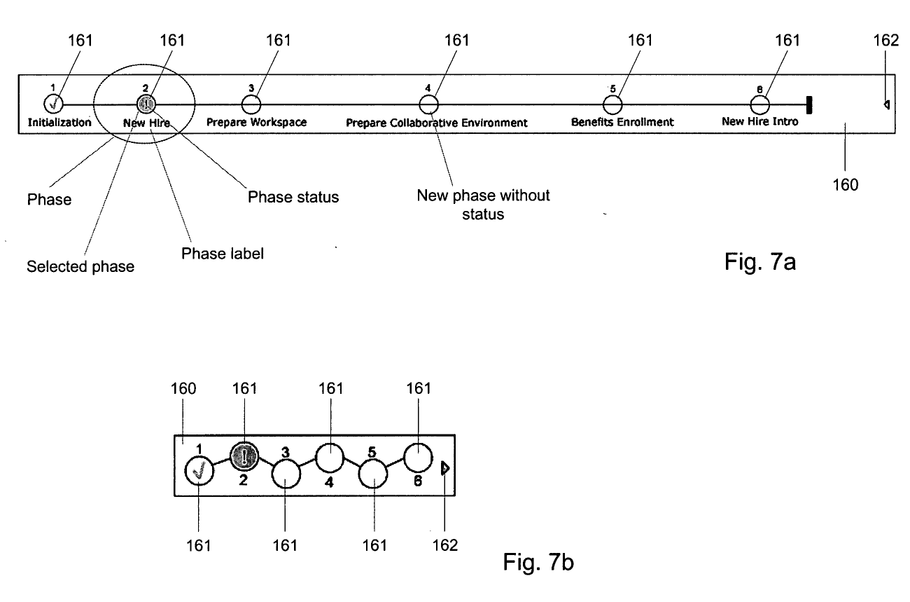

In the example shown in FIGS. 7a-7b, all items present in the expanded state remain visible in the collapsed state, but the items are positioned closer to each other in the collapsed state and additional information shown in the expanded state is not shown in the collapsed state. Thus, the user is presented with as much information in the collapsed state as in the expanded state, while the amount of space occupied by the interface is reduced.

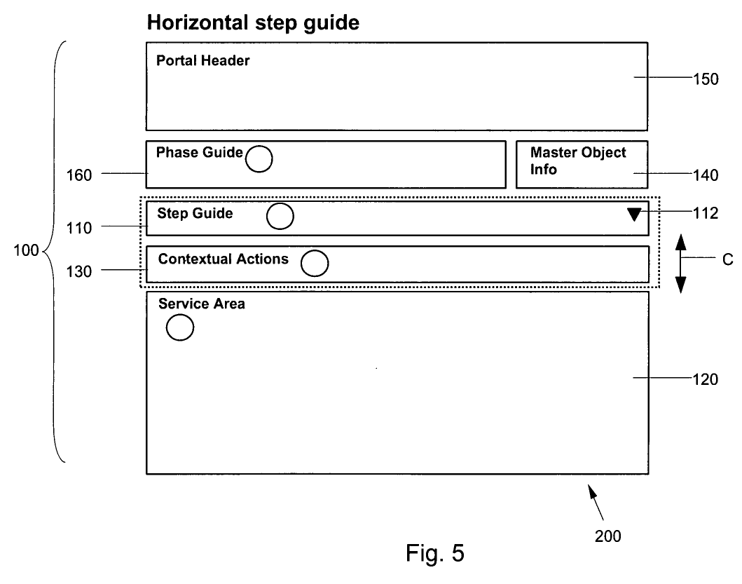

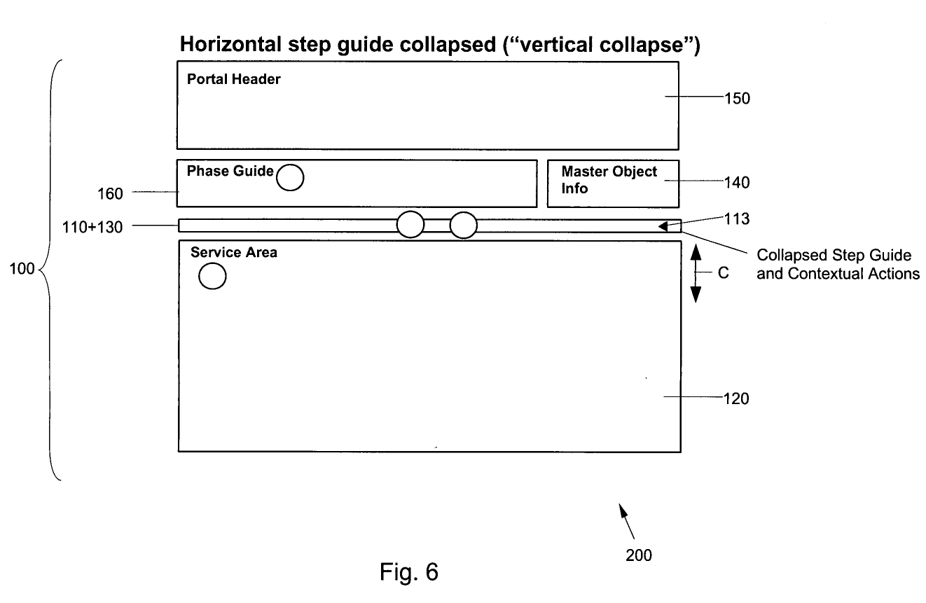

As illustrated in FIGS. 5-6, in which the collapsed state is shown in FIG. 6 and the expanded state is shown in FIG. 5, the dimensions of other interfaces may be coupled to those of item interface 110. For example, other interfaces may also be reduced when item interface 110 is brought into the collapsed state. In the example shown in FIGS. 5-6, the combined dimensions of the item interface 110 and the contextual interface 130 are reduced in the collapsed state compared to the expanded state, and the contextual interface 130 is hidden entirely in the collapsed state. In the contextual interface 130, controls and information related to a selected item 111 are shown. For example, a description of the item can be shown, controls to save, or edit the list of items or otherwise. Thus, when item interface 110 is not required and can be collapsed, the contextual interface is not required and can be collapsed as well. Accordingly, the amount of space cleared by the collapse is increased and information that is not needed is hidden, which reduces complexity and increases ease of use.

The size of one or more of the other interfaces may also be increased in response to collapsing item interface 110 in order to occupy the area released by the collapsed interface. In the examples shown in FIGS. 3 and 6, the size of service area 120 is increased by the change in area of interface 110 as item interface 110 changes from an expanded to a collapsed state. In service area 120, applications and other resources associated with the selected item of the list are displayed to assist the user. For example, when the items represent steps to be performed, in the service area applications and data useful in performing the step can be shown, such as for example available resources, addresses, or otherwise. By increasing the service area dimensions when item interface 110 collapses, more information can be presented in service area 120.

In the examples shown in FIGS. 2-6, item interface 110 is provided with a collapse control 112. However, other sub-interfaces in the graphical program interface 100 may also be provided with a collapse and/or expand control. For example, in FIGS. 7a-7b, a phase guide interface 160 suitable for the examples of FIGS. 2-6 is shown, which is provided with a collapse and expand control 162.

In the phase guide 160 of FIG. 7a, circle-shaped phase items 161 are shown which represent certain phases in the procedure to be performed. In FIG. 7a, the phases initialization, new hire, prepare workspace, prepare collaborative environment, benefits enrollment, and new hire introduction are shown. A user may select a phase item. In response to a user's selection, the steps to be performed in the selected phase are shown automatically as a list in item interface 110. The status of the phase is shown in the phase guide interface 160. When all steps associated with a phase have been performed, the circle for phase item 161 is checked to indicate that this phase is finished, as shown in FIGS. 7a-7b for the phase item “initialization.” The active phase item for which steps are being performed is marked. In this example, the marking is done with an exclamation mark. In FIG. 7a the active phase item is “new hire.”

In FIG. 7a, phase guide interface 160 is shown in an expanded state. Phase guide interface 160 has a collapse and expand control 162 by means of which the phase guide can be expanded and collapsed in a horizontal direction. In FIG. 7b, phase guide 160 is shown in a collapsed state.

In the expanded state, additional information, such as the phase name, is shown displayed below respective phase item 161. In the collapsed state, all items 161 that are shown in the expanded state are still visible in phase guide interface 160. However, items 161 are positioned closer to each other than in the expanded state. Furthermore, when phase guide interface 160 is brought into the collapsed state via control 162, the additional information is hidden. A user can thus still see all phases in the collapsed state and be informed about the states of the different phases.

In the examples of FIGS. 2-3 and 7a-7b, collapse controls 112/162 and expand control 113 also act as a status indicator that indicates which state the respective interface is in. In FIGS. 2-3 functions of expand control 113 and collapse control 112 are combined with a status indicator as a triangle-shaped button that points downward in the expanded state and points horizontally in the collapsed state. In FIGS. 7a-7b, the status indicator of control 162 is implemented as a triangle-shaped button that points in the direction to which the dimensions of phase guide interface 160 will be moved when brought in another state.

The computational aspects described here can be implemented in digital electronic circuitry, or in computer hardware, firmware, software, or in combinations of them. Where appropriate, aspects of these systems and techniques can be implemented in a computer program product tangibly embodied in a machine-readable storage device for execution by a programmable processor, and method steps are performed by a programmable processor executing a program that uses input data and generates output.

The invention may also be implemented in an article of manufacture with a computer usable medium having computer readable instructions embodied therein for providing access to resources available on that computer, the computer readable instructions comprising instructions to cause the computer to perform the steps of a method according to the invention. The invention may also be implemented as a computer program for running on a computer system, at least including code portions for performing steps of a method according to the invention when run on a computer system or enabling a general propose computer system interface to perform functions of a filter device according to the invention. Such a computer program may be provided on a data carrier, such as a CD-ROM or diskette, stored with data loadable in a memory of a computer system, the data representing the computer program. The data carrier may further be a data connection, such as a telephone cable or a wireless connection transmitting signals representing a computer program according to the invention.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A graphical user interface for a computer system, comprising:
an item interface in which at least two items can be listed and operable between an expanded state and a collapsed state,
a collapse control for bringing the item interface into a collapsed state in which dimensions of the item interface are partially reduced with respect to the expanded state and at least some of the items are not visible; and
an expand control for bringing the item interface from a collapsed state into the expanded state.

2. The graphical user interface of claim 1, wherein in the collapsed state the vertical dimensions of the item interface are reduced compared to the expanded state.

3. The graphical user interface of claim 1, wherein in the collapsed state the horizontal dimensions of the item interface are reduced compared to the expanded state.

4. The graphical user interface of claim 2, wherein the item interface comprises a fixed side that has the same position in the expanded state and the collapsed state, and a movable side substantially parallel to the fixed side, whereby the movable side lies closer to the fixed side in the collapsed state than in the expanded state.

5. The graphical user interface of claim 1, wherein the item interface has at least one select control for selecting at least one of said at least two items, and wherein in the collapsed state at least one selected item is visible in the item interface and unselected items are not visible in the collapsed state.

6. The graphical user interface of claim 1, wherein the item interface comprises at least one event control for initiating performing, at least partially by the graphical user interface, steps associated with at least one of the listed items.

7. The graphical user interface of claim 6, wherein the at least one event control initiates changes at the graphical user interface to display in another interface within the graphical user interface information that is associated with at least one of the listed items.

8. The graphical user interface of claim 1, wherein the collapse control, when activated, increases at least one dimension of another interface to cause the other interface to occupy an area formerly occupied by the item interface when in the expanded state.

9. The graphical user interface of claim 1, wherein the item interface comprises a state indicator that depicts whether the item interface is in the collapsed state or the expanded state.

10. The graphical user interface of claim 1, wherein when the item interface is in the collapsed state, at least two of the items are visible and positioned closer to each other than when the item interface is in the expanded state.

11. The graphical user interface of claim 10, wherein a horizontal space between the at least two of the items is smaller when the item interface is in the collapsed state than when the item interface is in the expanded state.

12. A method for manipulating an item interface in a graphical user interface of a computer device, the item interface having a list of at least two items, the method comprising:
reducing the dimensions of the item interface when the item interface is in an expanded state and bringing the item interface into a collapsed state in which the dimensions of the item interface are partially reduced and at least some of the items are not visible; and
increasing the dimensions of the item interface when the item interface is in the collapsed state to bring the item interface into the expanded state.

13. A computer program product, comprising program code portions for, when run on a programmable apparatus, performing steps of a method comprising:
reducing the dimensions of the item interface when the item interface is in an expanded state and bringing the item interface into a collapsed state in which the dimensions of the item interface are partially reduced and at least some of the items are not visible; and
increasing the dimensions of the item interface when the item interface is in the collapsed state to bring the item interface into the expanded state.

14. An article of manufacture with a computer usable medium having computer readable instructions embodied therein for providing access to resources available on that computer, the computer readable instructions comprising instructions to cause the computer to perform the steps of a method comprising:
reducing the dimensions of the item interface when the item interface is in an expanded state and bringing the item interface into a collapsed state in which the dimensions of the item interface are partially reduced and at least some of the items are not visible; and
increasing the dimensions of the item interface when the item interface is in the collapsed state to bring the item interface into the expanded state.
